(19) United States
(12) Patent Application Publication
(10) Pub. No.: US 2010/0019071 A1
(43) Pub. Date: Jan. 28, 2010

(54) Fuel injector armature guide

(76) Inventors: Robert B. Perry, Leicester, NY (US); Kevin J. Allen, Avon, NY (US); Richard L. Cooper, Leroy, NY (US)

Correspondence Address: Delphi Technologies, Inc., M/C 480-410-202, PO BOX 5052, Troy, MI, 48007, US

(21) Appl. No.: 12/220,105

(22) Filed: Jul. 22, 2008

(51) Int. Cl. F02M 51/06

(52) U.S. Cl. 239/585.4; 123/472

(57) ABSTRACT

An upper guide system for a solenoid actuated fuel injector of an internal combustion engine includes an armature having a first diameter section, a reduced diameter second section, and a concave portion at the transition between the first and second sections. The guide system also includes a guide shaped to extend into the concave portion of the armature and includes a central opening that slidably receives the second diameter section. The guide positions and guides the armature in a radial and an axial direction. The guide is assembled in an axial location that is close to the axial location of the center of the magnetic force acting on the armature. The guide system allows for a desired relative large guide length to diameter ratio.

### TECHNICAL FIELD

The present invention relates to fuel injection systems of internal combustion engines; more particularly, to solenoid actuated fuel injectors; and most particularly, to an upper guide system of an armature pintle assembly.

### BACKGROUND OF THE INVENTION

Fuel injected internal combustion engines are well known. Fuel injection arrangements may be divided generally into multi-port fuel injection (MPFI), wherein fuel is injected into a runner of an air intake manifold ahead of a cylinder intake valve, and direct injection (DI), wherein fuel is injected directly into the combustion chamber of an engine cylinder, typically during or at the end of the compression stroke of the piston. DI is designed to allow greater control and precision of the fuel charge to the combustion chamber, resulting in better fuel economy and lower emissions. This is accomplished by enabling the combustion of a precisely controlled charge of fuel under various operating conditions. DI is also designed to allow higher compression ratios, delivering higher performance with lower fuel consumption compared to other fuel injection systems.

Generally, an electromagnetic fuel injector incorporates a solenoid armature/pintle assembly, located between the pole piece of the solenoid and a fixed valve seat. The armature/pintle assembly typically operates as a movable valve assembly and, therefore, represents the moving mass of the fuel injector. Electromagnetic fuel injectors of the pulse-width type meter fuel per electric pulse at a rate proportional to the width of the electric pulse. In a normally closed injector, when an injector is de-energized, its movable valve assembly is released from one stop position and accelerated by a spring towards the opposite stop position, located at the valve seat.

The moving mass of a fuel injector must be guided in a radial direction to keep the pintle axially aligned with the seat in order for flow control across the seat to be robust and precise. Such a guide system is required to exhibit a minimal and consistent friction force in order for the injector to meter accurate fuel amounts and in order to provide a fuel flow rate within an established tolerance for the life of the parts of the armature pintle assembly. Moreover, DI Injectors require a relatively high fuel pressure to operate that may be, for example, as high as 3900 psi compared to about 60 psi required to operate a typical MPFI injector. Due to the higher operating pressure, the fuel flow of DI injectors is more sensitive to variations in the axial movement of the armature/pintle assembly than MPFI injectors.

Several methods to control the alignment of the moving mass of a fuel injector are currently employed. For example, in some cases, the pintle itself is used as the guide surface. However, since the guide location is axially distanced from the location of the radial load imposed on the armature by the magnetic forces, the friction imposed on the moving mass in the area of the guide surface is high.

In other prior art guide systems, the outside diameter of the armature is used as the guide surface. While this locates the guide location at the same axial location as the magnetic radial forces imposed on the armature, the surface area of the outside diameter of the armature that makes contact with the guide is much greater adding to the frictional losses imposed on the moving mass and contributing to a reduction in injector response time.

What is needed in the art is a system for guiding the moving mass of a solenoid-actuated injector that places the guide location near the radial load imposed on the armature by the magnetic forces of the solenoid to reduce friction.

What is further needed in the art is an upper guide system that has a favorable length to diameter ratio to improve the guiding function.

It is a principal object of the present invention to provide an armature guided fuel injector.

### SUMMARY OF THE INVENTION

Briefly described, a system for guiding the moving mass of a solenoid-actuated injector includes a guide assembled in an axial location that is near the location of the magnetic forces imposed on the armature by the injector's solenoid. An armature of an armature/pintle assembly, in accordance with the invention, includes a reduced diameter section. In one aspect of the invention, the guide is shaped to surround the reduced diameter section of the armature and to extend under a main section of the armature. The outer circumferential contour of the reduced diameter section of the armature functions as a guide surface. This allows for a relative large guide length to diameter ratio.

The upper guide is supported and positioned by a collar formed in the lower housing of the fuel injector. The collar also serves to locate the lower housing in the injector assembly. Additionally, the lower housing of the fuel injector includes a feature, serving as a lower guide, for guiding the valve of the armature/pintle assembly and, accordingly, enables the concentricity of the lower guide and the upper guide to be tightly controlled.

### BRIEF DESCRIPTION OF THE DRAWINGS

The present invention will now be described, by way of example, with reference to the accompanying drawing, in which:

FIG. 1 is a cross-sectional view of a lower part of a solenoid actuated fuel injector, in accordance with the invention; and

FIG. 2 is a cross-sectional view of an upper guide system, in accordance with the invention.

### DESCRIPTION OF THE PREFERRED EMBODIMENTS

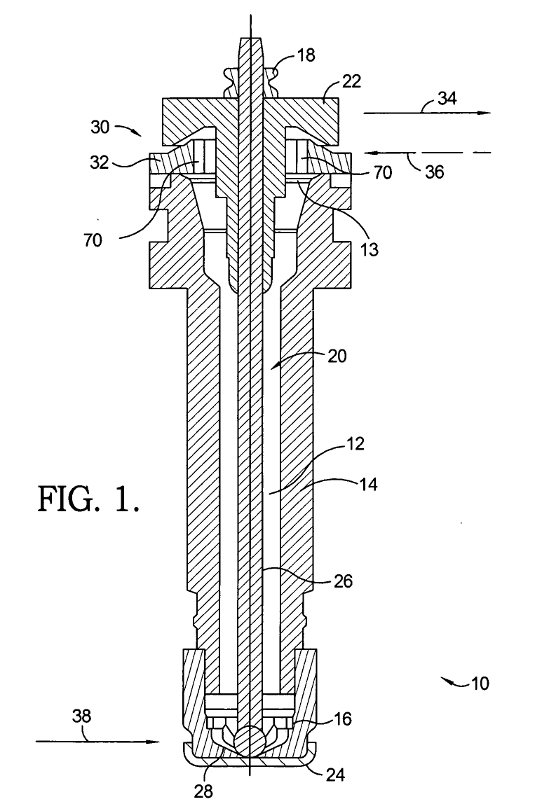

Referring to FIG. 1, a solenoid actuated fuel injector 10 includes a lower housing 12 enclosing a fuel passage 14, an armature/pintle assembly 20 disposed within fuel passage 14, and an upper guide system 30 and a lower guide system 16, both guiding armature pintle assembly 20.

Armature/pintle assembly 20 includes an armature 22 and a valve 24, such as a ball, positioned at opposite ends of a pintle 26. A valve seat 28 positioned at an end of lower housing 12 receives valve 24. Armature/pintle assembly 20 is assembled within lower housing 12 for reciprocating movement in axial direction within fuel passage 14.

Armature 22 is confined by but not fixed to pintle 26. This allows armature 22 to accelerate independent of pintle 26. A weld block 18 is fixed to an end of pintle 26 opposite from valve 24 and limits the axial upward movement of armature 22. When the moving mass of armature 22 collides with weld block 18, armature 22 rapidly lifts entire armature/pintle assembly 20 off valve seat 28, which reduces the opening time compared to armature pintle assemblies where armature 22 is in a fixed connection with pintle 26. Decoupling the mass of armature 22 from pintle 26 also reduces the impact on closing when valve 24 first makes contact with valve seat 28, which may reduce injector operating noise and may prevent unintended fueling by reducing the tendancy of the valve to bounce off the seat upon closing impact.

Axial movement of armature pintle assembly 20 is guided by upper guide system 30 and lower guide system 16. Upper guide system 30 is preferably positioned in close proximity to armature 22 and lower guide system 16 is preferably positioned in close proximity to valve seat 28. The axial location of upper guide system 30 is preferably chosen to be in close proximity to an axial location of the center of a radial load on armature 22 imposed by the magnetic forces of the injector solenoid.

As shown in FIG. 1, lateral magnetic force 34 acts radially on armature 22. By positioning upper guide system 30 near the center of mass of armature 22, reactive force 36 is imposed directly on armature 22, thereby significantly reducing reactive force 38 imposed on the valve at the lower guide point if reactive force 36 were not aligned with the center of mass of the armature.

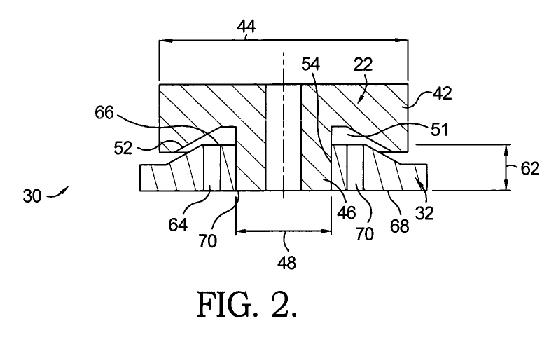

Referring to FIG. 2, upper guide system 30 includes armature 22 and a guide 32. Armature 22 includes a cylindrical main section 42 having a first outer diameter 44 and a cylindrical reduced diameter section 46 having a second outer diameter 48 that is smaller than the first diameter 44. Main section 42 defines a concave portion 51 in the transition between first diameter 44 and second diameter 48 and, therefore, includes inward curved surface 52. Reduced diameter section 46 extends axially from surface 52.

Cylindrical guide 32 has a length 62 and a central opening 64. Central opening 64 is designed for receiving reduced diameter section 46 of armature 22. Reduced diameter section 46 of armature 22 is reciprocably movable within central opening 64 of guide 32. Accordingly, an outer circumferential contour of reduced diameter section 46 becomes a guide surface allowing for a relatively large length 62 to diameter 48 ratio. Guide 32 positions and guides armature 22 and, consequently, armature/pintle assembly 20 in a radial and an axial direction.

Guide 32 includes a first surface 66 that extends into concave portion 51 of armature 22, thereby increasing the guide length without increasing the overall length of the guide and armature. Guide 32 includes a second surface 68 opposite first surface 66. Second surface 68 is preferably supported and located by a collar surface 13 of lower housing 12. Since lower housing 12 also locates lower guide system 16, the concentricity of the upper guide system 30 and the lower guide system 16 can be tightly controlled. Guide 32 further includes a plurality of apertures 70 that allow fuel to flow through guide 32 from above armature 22 into fuel passage 14. The number and size of apertures 70 may be chosen according to a desired flow rate. Guide surface 54 is lubricated by fuel flowing through central opening 64 of guide 32.

Guide 32 may be, for example, formed from hardened martensitic stainless steel. Central opening 64 of guide 32. A smooth surface on the outer circumferential contour of reduced diameter section 46 may have a smooth finish that may be achieved, for example, by grinding. To reduce wear, armature 22 or at least reduced diameter section 46 of armature 22 may be plated with a relatively hard material, such as chromium.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An upper guide system for a solenoid actuated fuel injector of an internal combustion engine, comprising:
an armature having a main section including a first diameter section and a second diameter section, said first diameter section having a diameter larger than a diameter of said second diameter section; and
a guide including a central opening adapted for slidably receiving said second diameter section, said guide positioning and guiding said armature in a radial and an axial direction.

2. The upper guide system of claim 1 wherein a transition between said first diameter section and said second diameter section of said armature defines a concave portion.

3. The upper guide system of claim 2, wherein said second diameter section extends from said first diameter section.

4. The upper guide system of claim 2, wherein said guide includes a first surface that extends into said concave portion of said armature.

5. The upper guide system of claim 1 further including a fuel injector lower housing, said lower housing including a collar surface, wherein said guide includes a second surface that is supported by the collar section of the lower housing.

6. The upper guide system of claim 1, wherein said guide is formed from hardened martensitic steel.

7. The upper guide system of claim 1, wherein at least said second diameter section of said armature includes a chromium surface.

8. The upper guide system of claim 1, wherein said guide includes at least one aperture that allows fuel to flow through said guide.

9. An armature guided fuel injector of an internal combustion engine, comprising:
a lower housing enclosing a fuel passage;
an armature/pintle assembly disposed for reciprocating movement in an axial direction within said fuel passage and including an armature at an upper end, said armature having a main section including a first diameter section and a second diameter section, said first diameter section having a diameter larger than a diameter of said second diameter section; and
an upper guide positioned proximite said armature, said guide including a central opening adapted for slidably receiving said second diameter section of said armature, said guide guiding said armature in a radial and an axial direction.

10. The armature guided fuel injector of claim 9, wherein a transition between said first diameter section and said second diameter section of said armature defines a concave portion.

11. The armature guided fuel injector of claim 9, wherein said second diameter section extends from said first diameter section.

12. The armature guided fuel injector of claim 10, wherein said guide includes a first surface that extends into said concave portion of said armature.

13. The armature guided fuel injector of claim 9 wherein said lower housing including a collar surface, and wherein said guide includes a second surface that is supported by the collar section of the lower housing.

14. The armature guided fuel injector of claim 9, wherein said guide includes at least one aperture that allows fuel to flow through said guide.
